(19) United States
(12) Patent Application Publication
(10) Pub. No.: US 2002/0140544 A1
(43) Pub. Date: Oct. 3, 2002

(54) Satellite trigger

(76) Inventor: Donald E. Steiner, Fort Myers, FL (US)

Correspondence Address: FRANK A. LUKASIK, APT. 142, 1250 WEST MARION AVE., PUNTA GORDA, FL, 33950, US

(21) Appl. No.: 09/823,311

(22) Filed: Apr. 2, 2001

(51) Int. Cl. H04Q 1/00

(52) U.S. Cl. 340/5.64; 340/7.1

(57) ABSTRACT

The present invention relates to remotely controlling devices through telephonically transmitted signals. A digital pager is used as an interface between a hardware device and a remote user to enable the user to activate or deactivate devices such as an automobile ignition system or other electric/electronic devices such as home security systems, gun locks or laptop computers, for example.

### FIELD OF THE INVENTION

The present invention relates to remotely controlling devices through telephonically transmitted signals and more particularly to a method of activating and deactivating devices such as an automobile ignition system or other electric/electronic devices attached to a pager.

### BACKGROUND OF THE INVENTION

Remote control devices have been in use for many years, particularly those wherein the signaling was done through wireless transmission. Devices from model aircraft to satellites in deep space have responded to such signals. Such devices require some means for receiving control signals and for converting those signals to some other, often mechanical, function. These devices require discrete signaling from transmitters set specifically to transmit only on a particular wavelength.

In U.S. Pat. No. 4,841,562 issued Jun. 20^{th} 1989 to Steven Lem, Lem discloses a telephonically activated device for remotely programming a VCR. In this device, Lem uses a purpose built computer to receive signals by phone and relay them to the VCR.

U.S. Pat. No. 4,885,766 issued Dec. 5^{th} 1989 to Yasuoka et al, discloses a remote control device which receives and stores signals transmitted telephonically for subsequent relay to a variety of other devices.

U.S. Pat. No. 5,915,026 issued Jun. 22^{nd} 1999 to Mankovitz discloses a system for programming home electronic devices using a computer to convert incoming signals to commands for various household devices.

The present invention dispenses with such sophisticated and expensive hardware, relying instead upon the ubiquitous digital pager. Digital pagers have become synonymous with “global” communication due to their response to satellite transmissions and while they are activated by RF signals transmitted on a very narrow band of the spectrum, they each respond to a unique digital signal. Such signal being simply transmitted via phone, cellular or conventional, being capable of accessing a central transmitter. It is this easily accessed global activation capability on which the present invention is based.

### SUMMARY OF THE INVENTION

It is therefore a basic object of the invention to simply and economically utilize digital pagers as an interface between a hardware device and a remote user to enable the user to telephonically activate or deactivate such hardware device(s).

It is a further object of the invention to provide a remote means whereby an automobile could be immobilized or stopped. In this instance, for safety reasons, the pager interface may be connected to a signaling means within the vehicle by which a thief or other unauthorized user could be advised of the ensuing deactivation of the vehicle. Further, a central database of access numbers to vehicles equipped as described above could be maintained (with permission of the vehicle owner) for access by police or other authorized persons. The object being to help police prevent high speed chases of vehicles which have been stolen.

It is a further object of the invention to provide a remotely activated interface using a digital pager whereby other electronic devices such as home security systems, door locks, padlocks, for example or other computer activated/controlled devices may be activated/deactivated.

It is a further object of the invention to utilize the pager's unique receiving/signaling means as a component in another electronic device or circuit which could thereafter be activated telephonically as a pager can. Such devices could include (and not be limited to) safety tags for young children in the form of a wrist or clothing affixed devices which could be activated remotely by a parent in the event the child is lost in a crowd. Such activation could include a voice alert to others present that the child is lost and giving contact directions for the parent.

It is a further object of the invention to build the pager interface as described, using modern technological advances in miniaturization to make a device which can be manufactured cheaply and integrated into other devices without becoming too bulky or inconvenient. Such miniaturization might include the use of integrated chips (IC) and for extreme miniaturization, large scale integration (LSI) where increased capacity is required in addition to size reduction.

It is a further object of the invention to provide a means whereby guns or other dangerous weapons may be stored and locked against unauthorized use only to be reactivated by an unlock code transmitted by the authorized user.

It is a further object of the invention to provide a means whereby laptop computers can be secured against theft of data through the application of a destructive static charge or other interference to the hard-drive through a remotely triggered device as described herein.

It is possible for one skilled in the art to envision other uses and applications of the present invention since the use of a digital pager as an activation/deactivation agent has such broad possibilities particularly with the recent proliferation of cell phones which make it convenient and practical to activate a pager controlled device from almost anywhere in the world.

### BRIEF DESCRIPTION OF THE DRAWINGS

FIG. 1 is a diagrammatic view of a preferred embodiment of the invention.

FIG. 2 is a diagrammatic view of a further embodiment of the invention in a mechanical configuration.

FIG. 3 is a diagrammatic view of a further embodiment of the invention in a mechanical configuration showing internal detail of a stepping switch used in FIG. 2.

FIG. 4 is a diagrammatic view of a further embodiment of the invention in a mechanical configuration wherein a toggle switch replaces the stepping switch of FIGS. 2, 3.

FIG. 5 is an elevational view partially in section of a further embodiment of the present invention.

FIGS. 6a and 6b are respectively top and bottom elevations of a further embodiment of the present invention.

FIG. 7 is a top elevational view of a further embodiment of the invention.

FIGS. 8 and 8 a side and front elevational views partially in broken section of the invention.

### DETAILED DESCRIPTION OF A PREFERRED EMBODIMENT

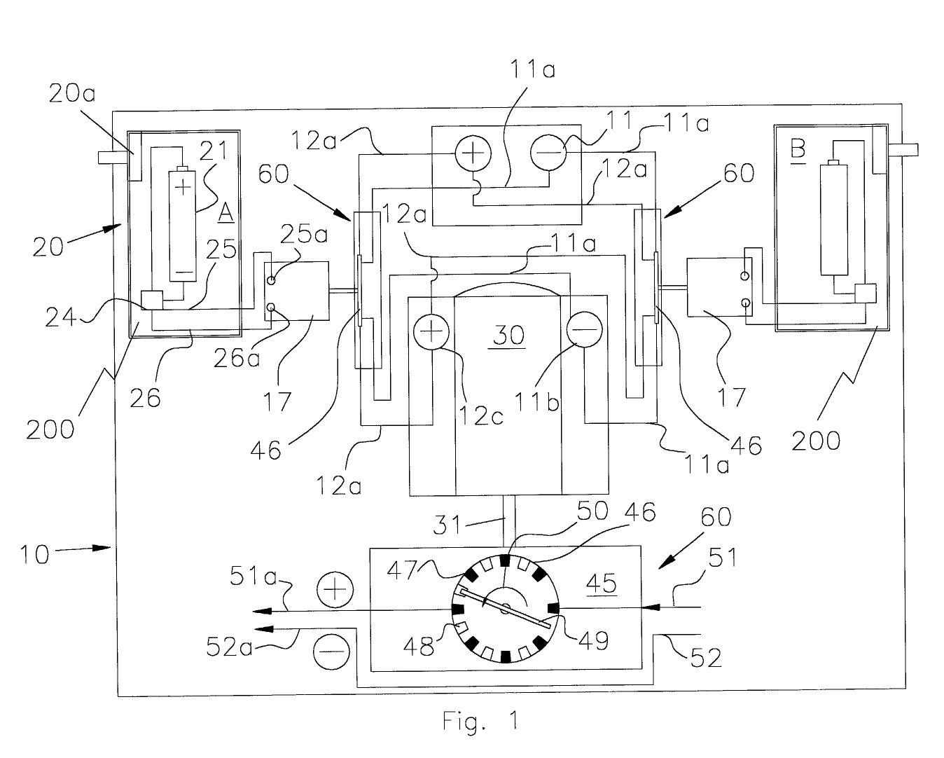

Referring now to the drawings wherein like numerals designate like and corresponding parts throughout the several views, in FIG. 1 the invention is designated overall by the numeral 10, a stepping switch assembly is designated overall by the numeral 60 and digital pager assembly/interface is designated overall by the numeral 20.

In operation, a key sequence occurs in which digital pager assembly 20 (A) is energized by a transmitted signal 200 and contact interface 24 relays electrical energy from pager battery 21 through wires 25 and 26 to terminals 25a and 26a. Electric motor 17 being momentarily energized, turns stepping switch rotor 46 (see stepping switch 60 assembly for detail as follows) contact arm 49 rotates in the direction of arrow 50 such that positive wire 12a (and 51a) can now transmit electricity and close the circuit from battery 13 so that electric motor 30 will pulse sufficiently to turn shaft 31 and switch rotor 46. FIG. 1 shows an alternative and duplicate digital pager assembly 20 (B) which is wired such that electric motor 30 can be pulsed in a reverse direction. Assemblies A and B are electrically separate from each other and are activated independently and separately.

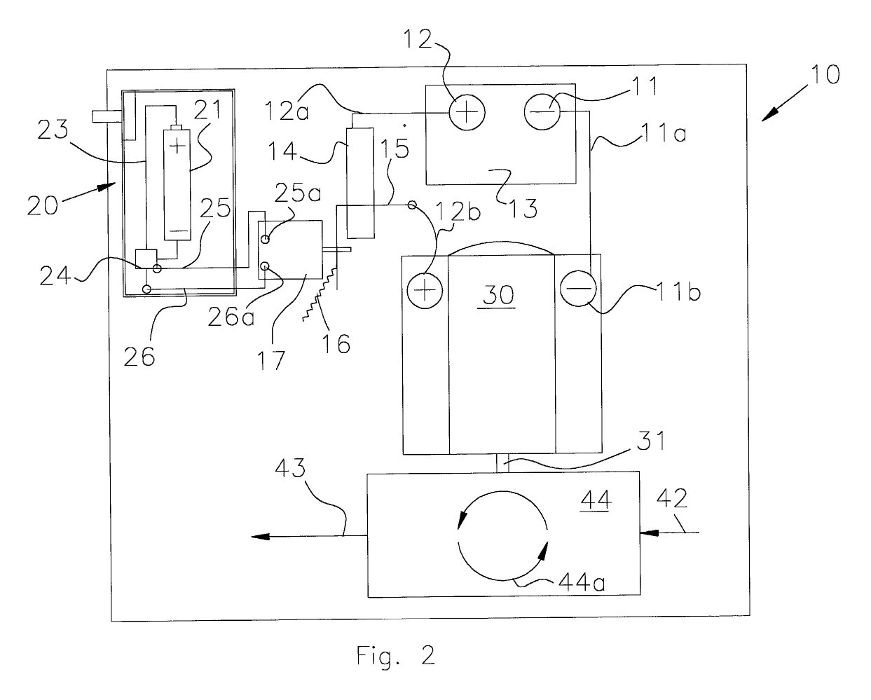

Referring now to FIG. 2 in which digital pager assembly 20 is wired as in FIG. 1. In FIG. 2, there is no stepping switch, there is instead a mechanical switch 15. In operation, digital pager assembly 20 is activated as described above but in this instance, the pulsing turn of motor 17 causes mechanical switch 15 to touch briefly against contact post 14. In so doing, battery 13 now has a closed circuit to electric motor 30shaft 31 pulses in the direction of arrows 44a and stepping switch 44 connects wires 42 and 43. Wires 42 and 43 represent any gauge of wire and any electrical load, similarly, electric motors 17 and 30 can be of any suitable size.

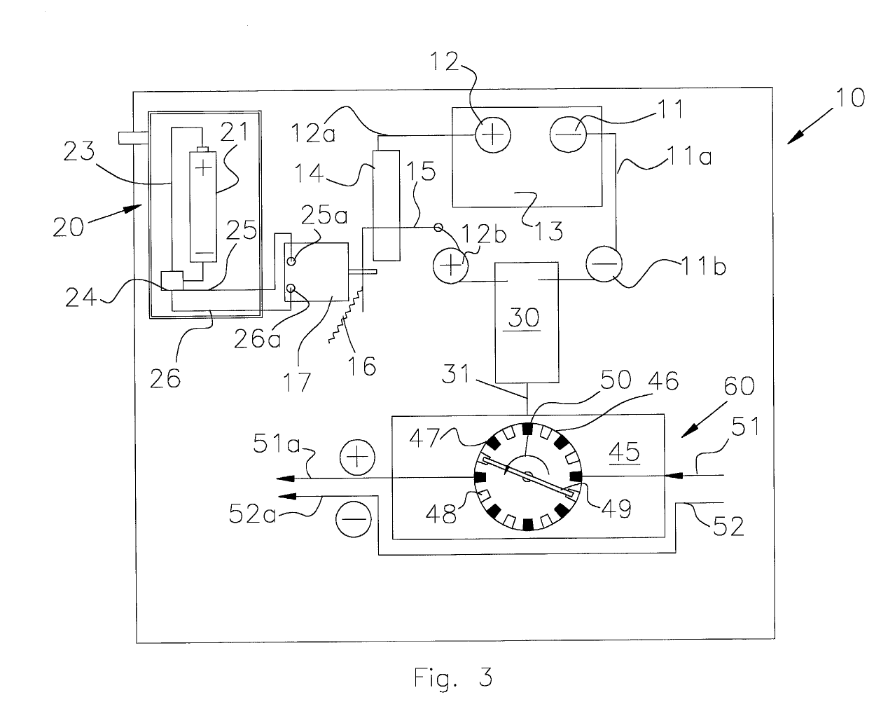

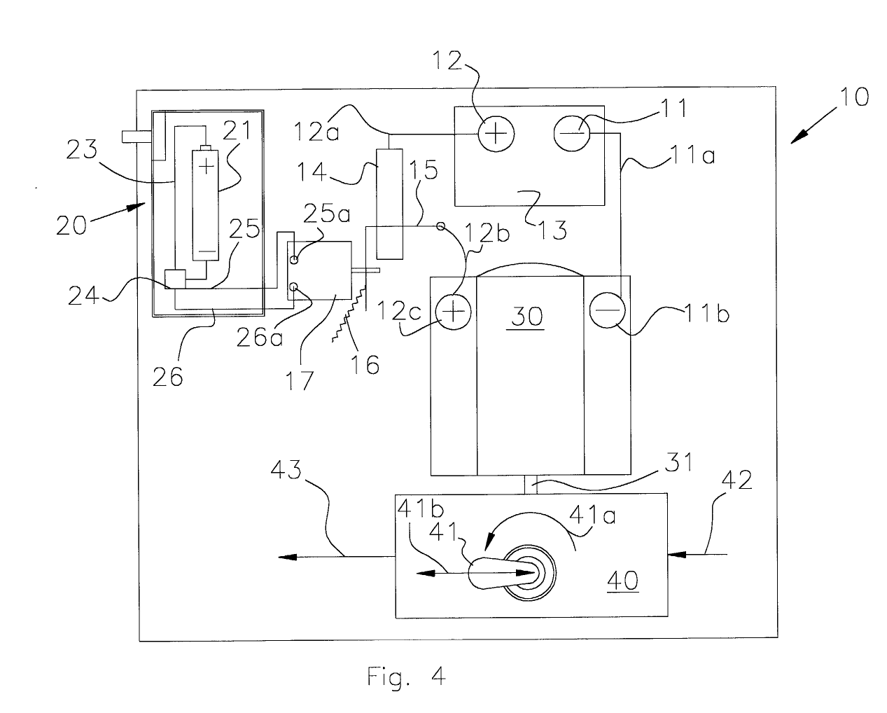

Referring now to FIG. 3 in which the circuitry is the same as in FIG. 2 and stepping switch assembly is as described in FIG. 1. It will be seen therein that alternate combinations of switch assemblies 60 and digital pager assemblies 20 can be used in both mechanical and fully electric configurations of the invention. The latter being further illustrated in FIG. 4 wherein switch 40 is activated as shown above but in only one direction being either switched on or off. Switch 40 has a mechanical reset switch 41 which is moved in the direction of arrows 41b. This embodiment lends itself to applications such as the immobilization of stolen vehicles wherein wires 42 and 43 as part of an automobile ignition circuit can be separated remotely and thereafter reset by hand using reset switch 41.

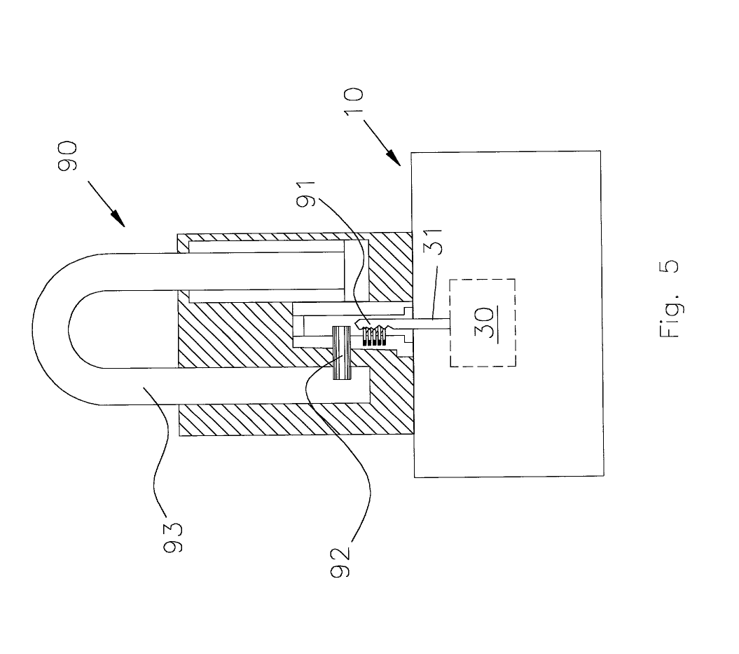

Referring now to FIG. 5 wherein a miniaturized version of the invention 10 with its electric motor 30 and shaft 31 as described are attached to padlock 90. Key assembly 91 is turned by shaft 31 to release lock pin 92 allowing hasp 93 to slide free.

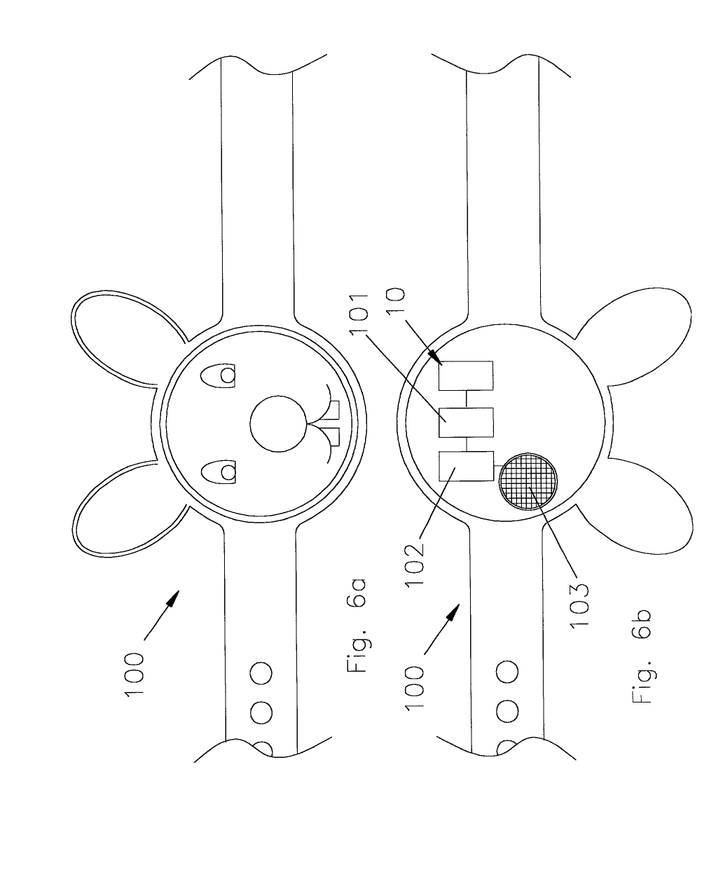

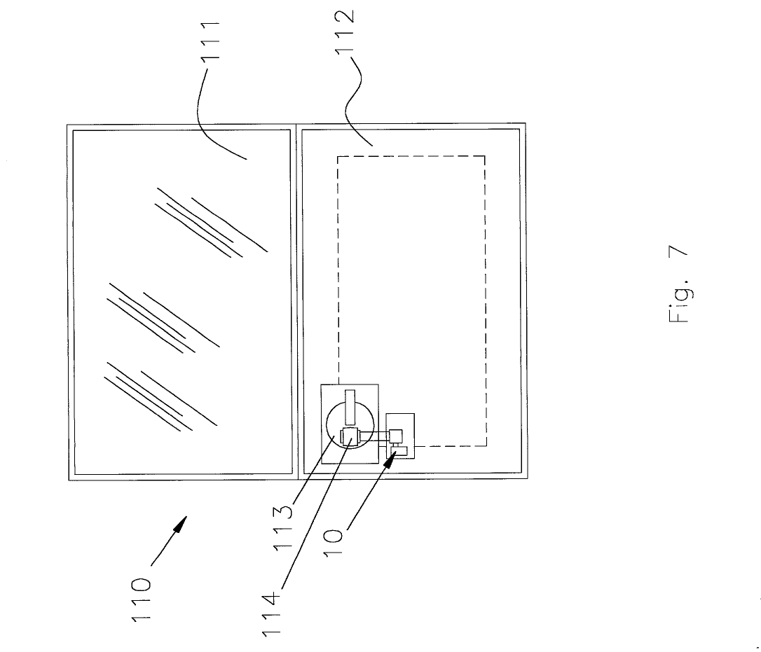

Referring now to FIG. 6a and 6b wherein child's security band 100 is fitted on its obverse (6b) with a miniaturized version of the invention 10 which energizes switching circuit 101 to activate audio/alarm circuit 102 to play through speaker 103. Circuit 102 can be programmed in various ways to draw public attention to a lost child.

Referring now to FIG. 7 in which laptop computer 110 is fitted with a miniaturized version of the invention 10 which activates as needed an electro-static pulse coil 114 attached to computer hard-drive 113. Regardless of whether lid 111 and body 112 are open or closed, the assembly 10 could be activated remotely to send a destructive electromagnetic pulse to the computer hard drive to prevent the theft of confidential data therein. Obviously the activation code for assembly 10 would remain known only to the authorized user of the computer.

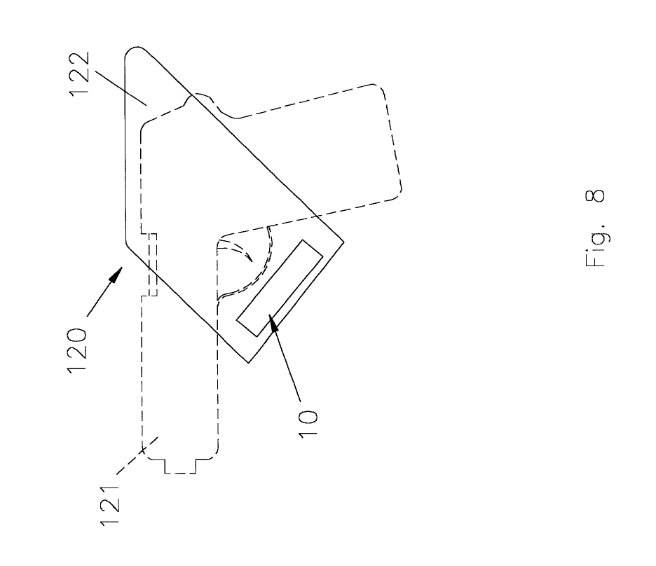

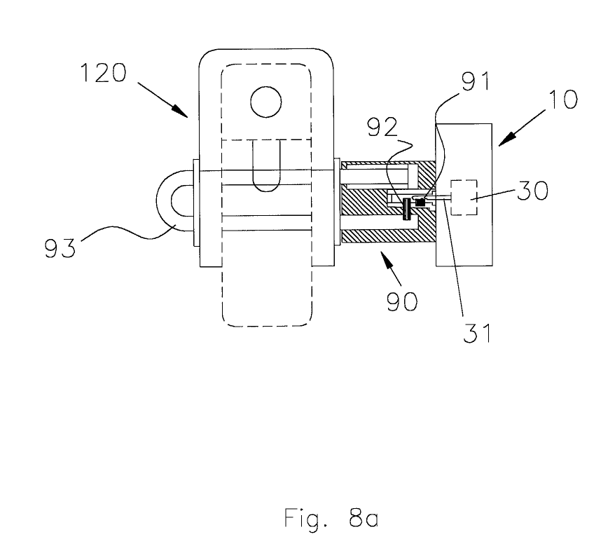

Referring now to FIG. 8 and 8a wherein gun 121 is secured by trigger guard 120. Shroud 122 completely covers the trigger assembly and is secured in place by lock 93 attached to a modified assembly of the present invention exactly as described in FIG. 5. Trigger guard 120 can only be removed by the owner or authorized user using the correct access code. It is conceivable that such access codes could be stored with police and government authorities who could cause the pager service to be deactivated in the event the owner became ineligible to legally possess the firearm.

What is claimed is:

1. A telephonically activated system for receiving control signals from a remote user and for converting those signals to some other function for activating and deactivating devices, said system comprising:
a digital pager assembly/interface for receiving a transmitted signal, said pager having a battery and a contact interface,
a first electric motor connected to said contact interface and powered by said pager battery,
a first switch means connected to and driven by said first electric motor, said first switch means having a battery power supply connected thereto,
a second electric motor connected to said first switch means and powered by said battery power supply,
a second switch means connected to and driven by said second electric motor,
said second switch means being adapted to activate and deactivate a selected device.

2. A telephonically activated system of claim 1 wherein said first switch means consists of a stepping switch.

3. A telephonically activated system of claim 1 wherein said first switch consists of a mechanical switch and a contact post.

4. A telephonically activated system of claim 1 wherein a second digital pager assembly having a battery and a contact interface are connected to a third electric motor and powered by said second pager,
a third switch means connected to and driven by said third electric motor, said third switch means having a battery power supply connected thereto, and said third switch being connected to said second electric motor for driving said second electric motor in an opposite direction of rotation.

5. A telephonically activated system of claim 1 wherein said second switch means consists of a mechanical reset switch.

6. A telephonically activated system of claim 1 wherein said digital pager assembly is miniaturized and said second electric motor is attached to and operates a padlock lock pin.

7. A telephonically activated system of claim 1 wherein said digital pager assembly is miniaturized and said second electric motor is attached to and operates a trigger guard.

8. A telephonically activated system of claim 1 wherein said digital pager assembly is miniaturized and an electro-static pulse coil is attached to a computer hard-drive to provide a destructive electromagnetic pulse to the computer hard drive to prevent the theft of confidential data therein.

9. A telephonically activated system for receiving control signals from a remote user and for converting those signals for activating and deactivating devices, said system comprising:
a miniaturized digital pager assembly, and
an audio/alarm circuit means connected to said pager assembly and powered by said pager assembly, said audio/alarm circuit being programmed to announce a message and having a speaker for audibly broadcasting said message.
